(19) United States
(12) Patent Application Publication
(10) Pub. No.: US 2025/0045381 A1
(43) Pub. Date: Feb. 6, 2025

(54) INTELLIGENT, ENTERPRISE RANSOMWARE DETECTION AND MITIGATION FRAMEWORK

(71) Applicant: Dell Products L.P., Round Rock, TX (US)

(72) Inventors: Vinotth Ramalingam, Plugerville, TX (US); Jay Alexander, Lehavim (IL); Bijan Kumar Mohanty, Austin, TX (US)

(21) Appl. No.: 18/365,352

(22) Filed: Aug. 4, 2023

(51) Int. Cl. G06F 21/55; G06F 21/56; G06F 40/295; G06F 40/40

(52) U.S. Cl. CPC G06F 21/552; G06F 21/56; G06F 40/295; G06F 40/40

(57) ABSTRACT

In one example method metadata about one or more entities of a ransomware threat and one or more relationships between the one or more entities of the ransomware threat is extracted from received cyber threat intelligence data by a threat decipher engine. The metadata about the one or more entities of the ransomware threat and the one or more relationships between the one or more entities of the ransomware threat is stored in a repository. A ransomware attack type included in received security sensor data is predicted by a threat prediction engine based on the metadata about the one or more entities of the ransomware threat and the one or more relationships between the one or more entities of the ransomware threat.

### FIELD OF THE INVENTION

Embodiments of the present invention generally relate to machine learning (ML) models. More particularly, at least some embodiments of the invention relate to systems, hardware, software, computer-readable media, and methods for deployment of an ML model in ransomware detection and mitigation.

### BACKGROUND

Ransomware is a form of malware designed to encrypt files on a device, rendering any files and the systems that rely on them unusable. Malicious actors then demand ransom in exchange for decryption. Ransomware incidents can severely impact business processes and leave organizations without the data they need to operate and deliver critical services. The attackers have adjusted their ransomware tactics over time to include pressuring victims for payment by threatening to release stolen data if they refuse to pay and publicly naming and shaming victims as secondary forms of extortion. The monetary value of ransom demands has also increased, with some demands exceeding US 1 million dollars.

To be successful, at a basic level a ransomware attacker needs to gain access to a target system, encrypt the files there, and demand a ransom from the victim. Typical ransomware attacks usually include a sequence of other steps that an attacker needs to complete before they can deploy the ransomware and extort the victim. Additionally, in each step there are multiple techniques that can be used to accomplish the attacker's objective in that step. This explains why there are many different ransomwares attack variants. Predicting the ransomware variant type and what will be the next step in an attack is exceedingly difficult.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a ransomware attack;

FIG. 2 discloses aspects of a ransomware prediction and mitigation system according to an embodiment disclosed herein;

FIG. 3 discloses aspects of the MITRE ATTACK framework;

FIG. 4 discloses example code for installing a SpaCy model;

FIG. 5 discloses example code for parsing a document using the SpaCy model;

FIG. 6 discloses example code for extracting entities using the SpaCy model;

FIG. 7 discloses example code for extracting relationships using the SpaCy model;

FIG. 8 discloses aspects of a Labeled Property Graph (LPG) according to an embodiment disclosed herein;

FIG. 9 discloses aspects of a threat prediction engine according to an embodiment disclosed herein;

FIG. 10 discloses aspects of training a threat prediction engine;

FIG. 11 discloses an example method according to an embodiment; and

FIG. 12 discloses an example computing entity configured and operable to perform any of the disclosed methods, processes, and operations.

### DETAILED DESCRIPTION OF SOME EXAMPLE EMBODIMENTS

Embodiments of the present invention generally relate to machine learning (ML) models. More particularly, at least some embodiments of the invention relate to systems, hardware, software, computer-readable media, and methods for deployment of an ML model in ransomware detection and mitigation.

This invention proposes an intelligent, predictive framework that uses an NLP model to extract entities of a ransomware threat from third-party threat intelligence sources and builds a ransomware threat/attack repository using a graph database. This repository is then used to train a sophisticated Neural Network based Machine Learning model to predict a ransomware threat by classifying the scan from various security tools such as, but not limited to XDR and EDR.

In one example method metadata about one or more entities of a ransomware threat and one or more relationships between the one or more entities of the ransomware threat is extracted from received cyber threat intelligence data by a threat decipher engine. The metadata about the one or more entities of the ransomware threat and the one or more relationships between the one or more entities of the ransomware threat is stored in a repository. A ransomware attack type included in received security sensor data is predicted by a threat prediction engine based on the metadata about the one or more entities of the ransomware threat and the one or more relationships between the one or more entities of the ransomware threat.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment of the Invention

Organizations are using various tools and techniques to safeguard from Ransomware attacks, but it is extremely hard to predict a pattern and in worse Ransomware can remain dormant on a device until the device is at its most vulnerable, and only then execute an attack. The COVID-19 pandemic also contributed to the recent surge in ransomware. As organizations rapidly pivoted to remote work, gaps were created in their cyber defenses. Cybercriminals have exploited these vulnerabilities to deliver ransomware, resulting in a surge of ransomware attacks.

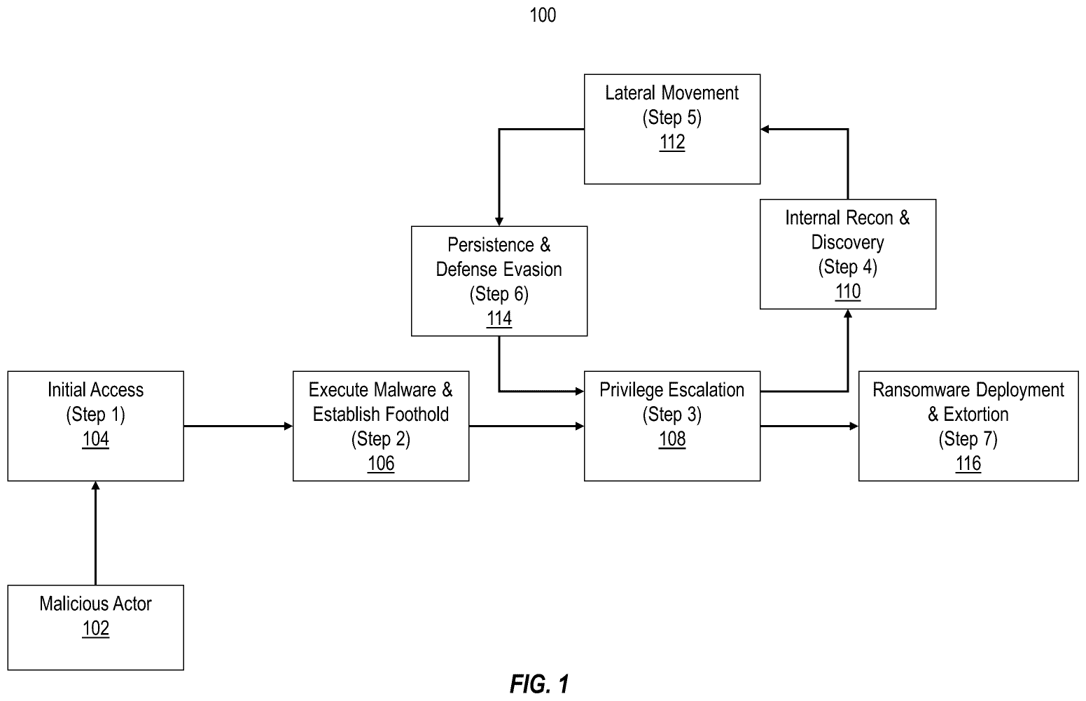

FIG. 1 illustrates an example of a typical ransomware attack path 100 that is initialized by a malicious actor 102. The ransomware attack path 100 is as follows:
Step 1: Initial Access 104. During this step, the malicious actor 102's first main objective is to gain initial access to an organization, or more precisely the computing system or network of the organization, of their victim. The initial access is obtained via various ways including, but not limited to, exploit of comprised valid credentials, exploit of public-facing systems that have built in vulnerabilities, exploit of customer-facing Graphic User Interfaces (GUI), and/or exploit of physical access
Step 2: Execute Malware and Establish Foothold 106. During this step, the malicious actor 102 downloads malware and hacking tools onto critical path systems including jump hosts and virtual infrastructure of the compromised computing system or network. These are required for the malicious actor 102 to continue down the attack path.
Step 3: Privilege Escalation 108. In this step, the malicious actor 102 begins the hunt for the credentials to allow them to move laterally throughout the computing system or network in search for the crown jewels of the organization: Administrator access to Active Directory on the Domain Controller Server.
Step 4: Internal Recon and Discovery 110. In this step, the malicious actor 102 scans the computing system or network to find ways to move laterally to other clients and servers. This may be done using scripts and built-in tools.
Step 5: Lateral Movement 112. In this step, the malicious actor 102 tries to move laterally across the computing system or network. This may be done using stolen credentials and remote services.
Step 6: Persistence and Defense Evasion 114. Having gained access to compromised accounts across the computing system or network, the malicious actor 102 will usually cement their presence in the computing system or network to safeguard their presence and will typically deactivate existing security systems to evade detection.

As shown in FIG. 1, steps 3-6 may be repeated as many times as needed until the malicious actor 102 gains sufficient privilege to move onto step 8.
Step 8. Ransomware Deployment and Extortion 116. In this step, the malicious actor 102 deploys ransomware and encrypts systems across the compromised organization to stop the compromised computing system or network from working properly. Some variants will also take steps to delete backup and shadow copies of files to make recovery without the decryption key more difficult. The malicious actor 102 will then extort the organization for some monetary gain to provide any decryption keys needed to restore the computing system or network to work properly or to not publish any sensitive data that is located on the compromised computing system or network.

A successful ransomware attack can thus have significant impact on a business organization in terms of cost, service disruption, reputation, etc. For example, ransomware gangs are increasingly using multi-extortion techniques to strong arm the victim organization into paying the ransom demand. And recovering from a successful ransomware attack is a difficult task. Thus, it is important to be proactive to monitor, track all endpoints and network traffic and verify any anomaly against the known ransomware techniques to predict an attack.

This is difficult, however, as ransomware groups are continually developing variants to target additional operating systems, such as Linux, or leveraging highly customizable programming languages, such as Rust, to create ransomware attacks more easily. It is clear the malicious actors will continue to create new variants and build out their capabilities to target all kinds of systems, which will widen the scope of possible victims in the process.

### B. Example Problems that May be Addressed by an Embodiment of the Invention

Existing ransomware detection mechanisms exist that attempt to detect and mitigate ransomware attacks. However, the existing ransomware detection mechanisms are usually reactive in nature and lack intelligence and insight to be predictive and proactive. Thus, there are at least three fundamental problems with the approaches used by the existing ransomware detection mechanisms. One of such problems is that the existing ransomware detection mechanisms do not have the intelligence to detect, with high degree of confidence, on the potential ransomware attacks without using a vast source of intelligence from third party ransomware watchdogs like CISA repository, TrendMicro intelligent feeds and Cyware threat intelligence feeds. In some instances, the existing ransomware detection mechanisms lack access to the intelligence provided by these tools.

Another problem is that the existing ransomware detection mechanisms lack a centralized repository of ransomware attack with the ransomware techniques, variants, assets, vulnerabilities, and targets with their relationships. This gap in the capabilities creates a hinderance to provide an effective, predictive framework for ransomware attack and mitigation.

A final problem is that the existing ransomware detection mechanisms lack an intelligent prediction of which transactions are ransomware attacks and which are normal and what are the mitigation schemes in case of a ransomware attack is predicted. This gap in the capabilities creates a hinderance to provide effective mitigation strategies to the victim of the ransomware attack.

### C. Detailed Description of an Example Embodiment of a Ransomware Prediction and Mitigation System

### C.1 Overview

The embodiments disclosed herein provide for an innovative, predictive, and intelligent framework for predicting and mitigating ransomware attacks in an automated manner. This automation creates the need for organizations to implement a defensive technique to adapt and add the latest capabilities to minimize the attack surface. In order to better prevent ransomware, it is critical to understand the tactics attackers use to deliver this threat. There are multiple ransomware variants in use across multiple attack vectors, including through the network, SaaS-based applications and directly to the endpoint.

The example embodiment of the ransomware prediction and mitigation system collects known ransomware threat vectors and data from multiple sources. The system also has a curated dataset of attacks which contain information of successful past attacks. An AI-powered natural language processing technique is used to train the system on information from threat intelligent sources and the MITRE ATTACK (also known as MITRE ATT&CK) framework to model known ransomware attack information into a graph database. The ransomware attack graph database provides a model and relationships of attack techniques, and other attack metadata types. The data nodes and the relationships between the nodes provide a comprehensive model and database of known ransomware attacks. The system uses an ML engine or model that can match indictors that are fed into the ML engine from existing security tools such as, but not limited to, EDR and XDR network security tools and then detects the ransomware variant and predicts the next steps in the attack.

In summary, the embodiments disclosed herein (1) identify successful attacks in progress and predict the next attack techniques that may be used, on what asset types, exploiting which vulnerabilities, etc., (2) provide mitigations and actions to take to defend against the attack in progress, and (3) model known ransomware attacks, their attributes and metadata and the relationships between all the data nodes.

### C.2 Example Architecture According to One Embodiment of the Invention

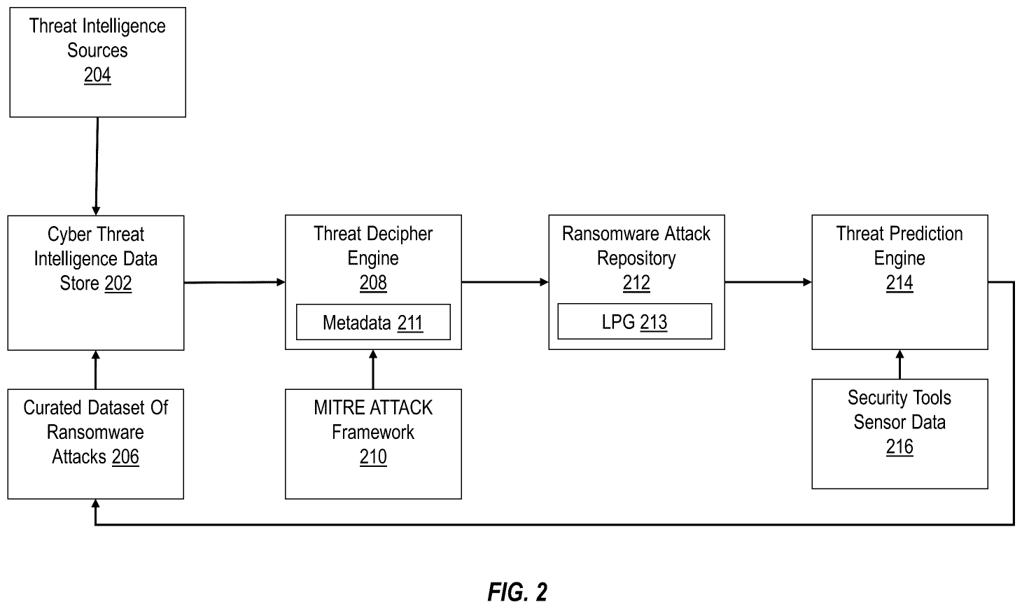

With attention now to FIG. 2, an example architecture, and associated methods and operations, according to one embodiment of a ransomware prediction and mitigation system are denoted at 200. As shown in the figure, the ransomware prediction and mitigation system 200 includes a cyber threat intelligence store 202. In operation, the cyber threat intelligence store 202 collects known cyber threat intelligence data from known threat intelligence sources 204. The threat intelligence sources 204 may be governmental sources such as the CISA repository or private sources such as the TrendMicro intelligence feeds or the Cyware threat intelligence feeds. Thus, the cyber threat intelligence store 202 may receive various threat intelligence feeds from the threat intelligence sources 204. It will be understood that a threat intelligence feed, in one embodiment, is a real-time, continuous data stream that gathers information related to cyber risks or threats. Data usually focuses on a single area of cybersecurity interest, such as unusual domains, malware signatures, or IP addresses associated with known threat actors.

The ransomware prediction and mitigation system 200 includes a curated dataset of ransomware attacks 206 that are also provided to the cyber threat intelligence store 202. The curated dataset of ransomware attacks 206 contains historical information of successful past ransomware attacks. This historical information may be obtained from previous operation of the ransomware prediction and mitigation system 200 or it may be obtained from other sources.

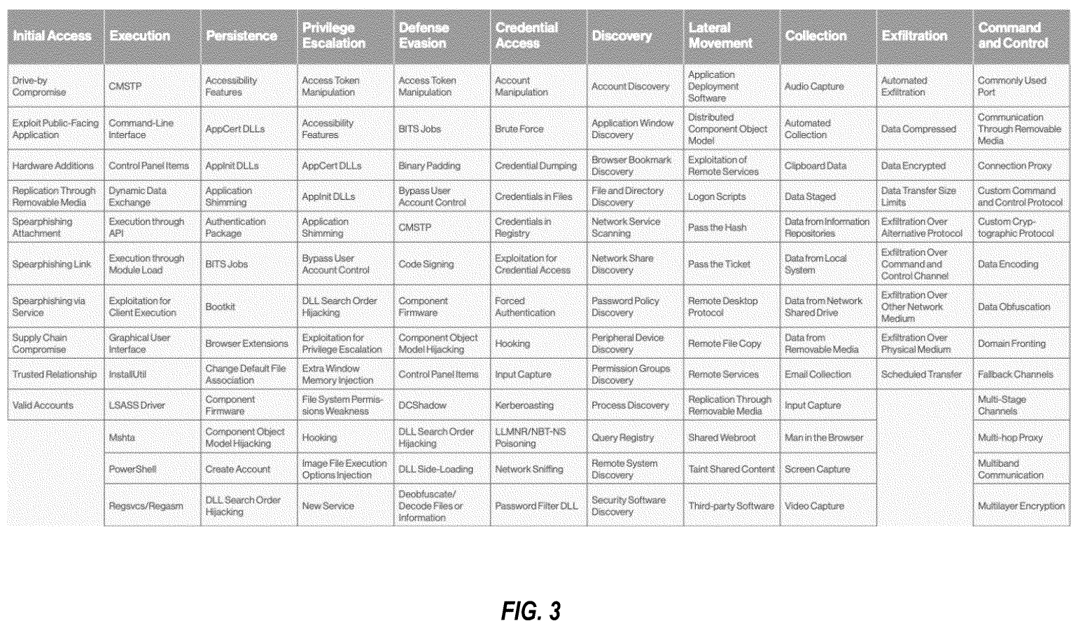

The known cyber threat intelligence data stored in the cyber threat intelligence store 202 is provided to or otherwise accessed by a threat decipher engine 208. In some embodiments, the threat decipher engine 208 also receives information from the MITRE ATTACK framework 210. The MITRE ATTACK framework 210 is a curated knowledge base that tracks cyber adversary tactics and techniques used by threat actors across the entire attack lifecycle. The framework is meant to be more than a collection of data: it is intended to be used as a tool to strengthen an organization's security posture. For instance, because the MITRE ATTACK framework 210 takes the perspective of the adversary, security operations teams can more easily deduce an adversary's motivation for individual actions and understand how those actions relate to specific classes of defenses. An example embodiment 300 of the MITRE ATTACK framework 210 is shown in FIG. 3, where each of the columns describe steps in ransomware attack similar to those described in relation to FIG. 1 and each cell in the column describes a known action related to the attack step. Thus, the MITRE ATTACK framework 210 provides additional information about a ransomware attack to the threat decipher engine 208.

As will be explained in further detail, the threat decipher engine 208 extracts threat intelligence metadata 211 from the cyber threat intelligence data received or obtained from the cyber threat intelligence store 202 and the MITRE ATTACK framework 210. The threat decipher engine 208, which in one embodiment may comprise a Natural Language Processing (NLP) ML model, is able to find relationships between the entities found in the threat intelligence metadata 211.

As will be explained in more detail to follow, the relationships that are extracted from the threat intelligence metadata 211 are stored in a ransomware attack repository (also referred to as a ransomware attack graph database) 212 for further use. The ransomware attack repository 212 maps relationships between known ransomware attack characteristics and the threat intelligence metadata 211. Accordingly, in one embodiment the ransomware attack repository 212 comprises a Labeled Property Graph (LPG) 213 that shows a graphical representation of the relationships between known ransomware attack characteristics and the threat intelligence metadata 211.

As will be explained in more detail to follow, the relationships stored in the ransomware attack repository 212 are received by or otherwise accessed by a threat prediction engine 214, which in one embodiment may comprise a ML classifier model that implements categorical boosting algorithms. In operation, the threat prediction engine 214 receives sensor data from security tools 216 such as, but not limited to, Extended Detection and Response (XDR) and Endpoint Detection and Response (EDR) security tools. The security tools 216 provide cyber attack monitoring and so the sensor data received from these tools may be considered as input into a computing system that may be the subject of a ransomware attack. Thus, multiple different security tools can provide input into the system.

The threat prediction engine 214 is trained using the relationships stored in the ransomware attack repository 212 and then predicts if the sensor data from the security tools 216 is a ransomware attack or not. Specifically, the ML models of the threat prediction engine 214 use the real time detections from the security tools 16 and the relationships stored in the ransomware attack repository 212 to identify ransomware attacks in progress, the impacted assets, vulnerabilities being exploited, and many specific attack characteristics of the attack in progress. The results of the threat prediction engine 214 can then be provided to the curated dataset of ransomware attacks 206 for future use of the ransomware and mitigation system 200 in predicting and mitigating ransomware attacks.

Since the ransomware attack repository 212 also provides accurate predictions on the next steps in the ransomware attack path, it is possible for the threat prediction engine 214 to predict what actions the attacker is likely to next take, what assets are likely to be attacked next, what systems are vulnerable to the ransomware attack, etc. This enables defenders to take proactive defensive actions to stop the attack from propagating, eradicate the attacker from the environment and mitigate risks due to the attack.

Briefly then, the example embodiment of the ransomware and mitigation system 200 may be implemented to comprise various components. These components may include the threat decipher engine 208, the ransomware attack repository 212, and the threat prediction engine 214. These components, which may each comprise a respective ML model to carry out their respective functions, are considered in turn below.

### C.2.1 Aspects of an Example Threat Decipher Engine

As mentioned above, the threat decipher engine 208 extracts the threat intelligence metadata 211 from a variety of cyberthreat intelligence data received from multiple sources including the CISA repository, TrendMicro intelligent feeds, Cyware threat intelligence feeds as well as MITRE Attack framework 210 and the curated dataset of ransomware attacks 206. Considering that the intelligence feeds are in the form of documents, the threat decipher engine 208 is configured as an NLP model. In operation, the threat decipher engine 208 uses sophisticated NLP models and Named Recognition Entity (NER) and Relationship Extraction (RE) techniques to decipher the threat intelligence metadata 211 from the received documents. The threat intelligence metadata 211 in the form of entities and relationship between the entities are crucial to store in the ransomware attack repository 212 for threat prediction and mitigation strategies.

NLP Named Recognition Entity (NER) is the process of identifying the word or phrase spans in the unstructured text and classifying them as belonging to a specific class. For example, in ransomware use cases the different classes of entities could be assets, techniques, ransomware variants, vulnerabilities, etc. Relationship extraction is the process of identifying the relationships implied in the text between a pair of entities. In ransomware use case, examples of relationships could be targets, attacks, utilizes, uses, etc. For example, in the following sentence “Microsoft Windows 10 has Elevation Privilege Vulnerability”, the entities and relationship as extracted are shown in Table 1 below:

| Entity | Relationship | Entity |
|---|---|---|
| Microsoft | has | Elevation Privilege |
| Windows 10 | | Vulnerability |

By applying NER techniques of NLP, the threat decipher engine 208 will convert a variety of threat intelligence documents into a list of entities and their class. For example, in the above sentence “Microsoft Windows 10” entity falls under asset class where as “Elevation Privilege Vulnerability” falls under Vulnerability class.

Relationship Extraction (RE) process on the same sentence extracts the relationship between the two entities. Just like NER step, RE also extracts structured information from unstructured or semi structured data. When applied over a large collection of text that has gone through the NER process, RE process can extract graphs which are foundational for building the knowledge graph on any domain. In this case, this process will extract the threat intelligence metadata 211 from the text and manage them in a graph repository for threat modeling, training, prediction, and mitigation.

There are many solutions for achieving NER and RE including sophisticated transformers like BERT, GPT, etc. One embodiment leverages SpaCy, an open-source library for advanced natural language processing and text analysis using Python. It is used to build information extraction or natural language understanding systems, or to pre-process text for deep learning. SpaCy has many pre-trained models with various sizes for NLP and NER as well as RE tasks as well as transformers. It can also be trained with domain specific data for understanding and extraction of enterprise domain specific documents.

The following are the features that SpaCy offers:
1. Tokenization: Segmenting a text into words, punctuation, etc.
2. Part of speech tagging: Assigning word types to token like noun and verbs
3. Dependency parsing: Describing relationship between subjects and objects
4. Lemmatization: Breaking the word to its root; for example, making Running to Run
5. Sentence boundary detection: Finding and segmenting individual sentences.
6. Named Entity Recognition: Finding the entities and their class in the sentence
7. Relationship Extraction: Extract the relationship between a pair of entities.

In the embodiment, SpaCy is used for Named Entity Recognition and Relationship Extraction. The steps and the code used to extract the threat intelligence metadata 211 is discussed below.

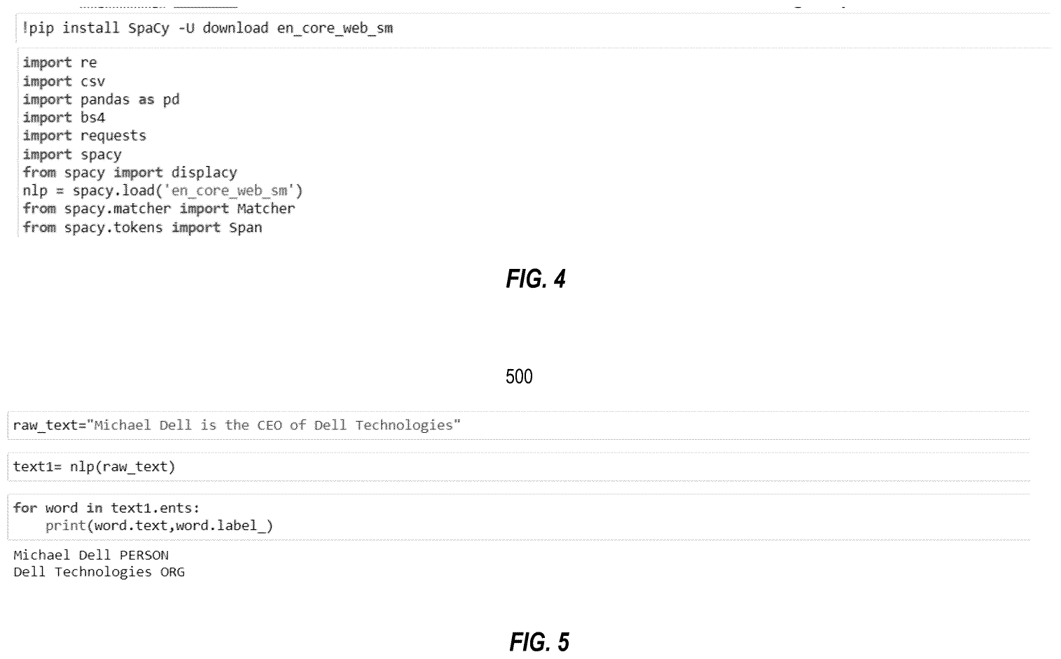

First, SpaCy needs to be installed using Pip Install. FIG. 4 discloses code 400 for performing this operation.

Next raw text is passed to the SpaCy model as loaded in the variable NLP. The whole document containing multiple sentences can be passed (one sentence at a time) to retrieve the entities in that sentence. FIG. 5 discloses code 500 for performing this operation. The class of each entity is extracted as well; for example, in this example Michael Dell is correctly identified as a PERSON class whereas Dell Technologies is identified as an ORG (Organization or a corporation).

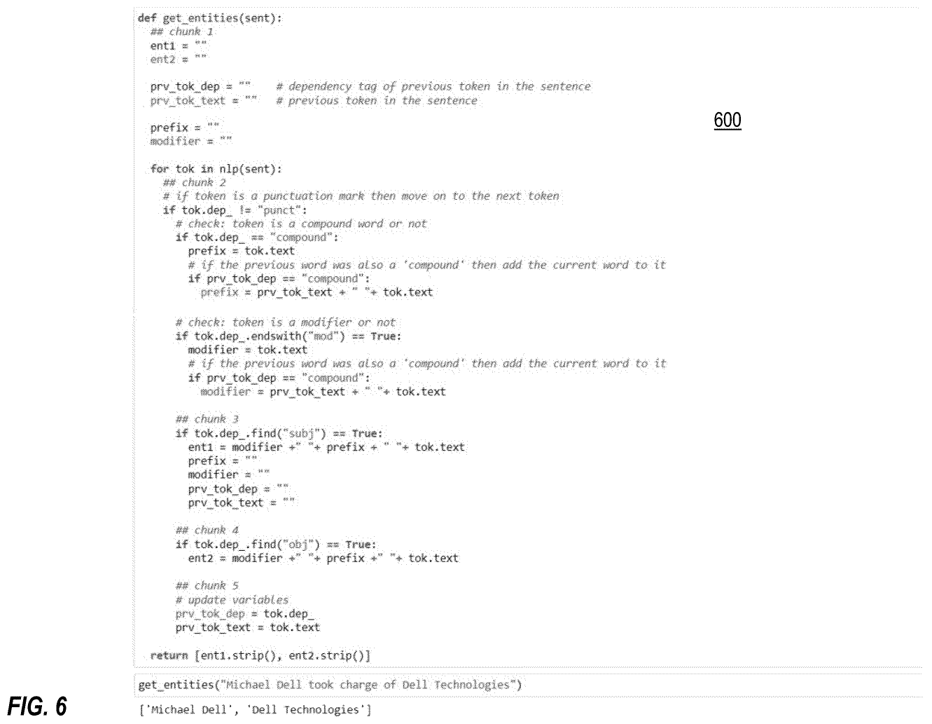

For large text with multiple sentences, the code 600 shown in FIG. 6 can be used as a function to extract entities using the same language model.

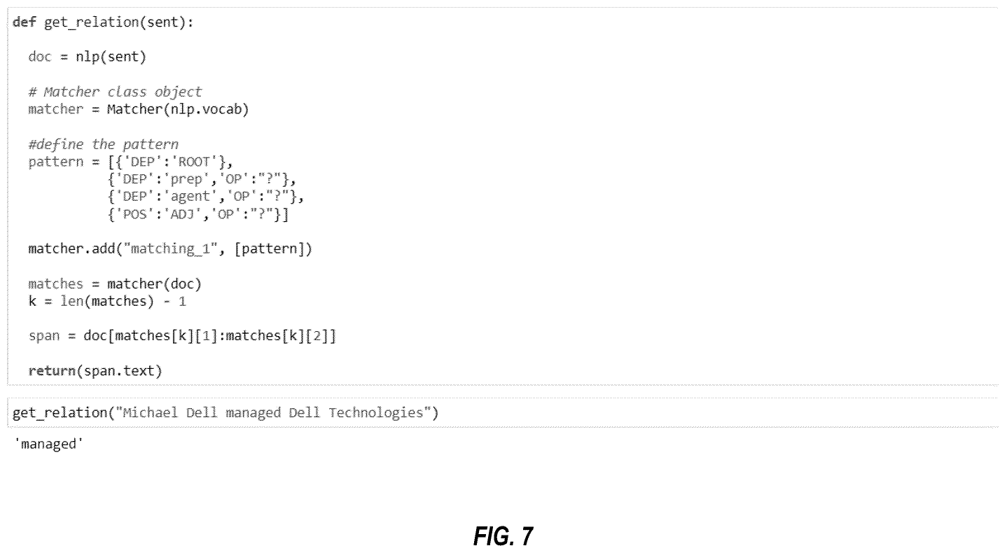

Similar functions can be written to extract the relationship between two entities in a sentence. FIG. 7 discloses code 700 for performing this operation.

### C.2.2 Aspects of an Example Ransomware Attack Repository

The ransomware attack repository 212 embodies the management of the threat intelligence metadata 211 as extracted by the threat decipher engine 208. The threat intelligence metadata 211 includes various entities, relationships and concepts in the threat intelligence documents and is used to build the contexts and semantics in the form of a graph for efficient processing (storage and retrieval) of threat domain knowledge.

Considering the complexities of the associations between the entities, a graph database is suitable for use in this case. There are two main approaches to storing and retrieving information as graph. They are:

Resource Description Framework (RDF): RDF formats the information (entity and relationship) as a Triple (subject-predicate-object). For example, an asset (Windows10) has a vulnerability (elevation privilege) is stored as Subject (Windows10)→Predicate (has)→Object (Elevation privilege vulnerability). The subject will be a resource or node/entity in the graph. The predicate will represent an edge—a relationship, and the object will be another node. These nodes and edges are identified by URI which is a unique identifier. They do not have any internal structure; they are just labeled by the URI. This type of model is great for data exchange.

Labeled Property Graph (LPG): In this type of graph, each entity is represented as a node which have a uniquely identifiable ID, and a set of key-value pairs, or properties that characterize them. The relationship between two entities are represented as an edge or connection between the nodes. Relationships have an ID to uniquely identify them as well as a type. They also have a set of key-value pairs as properties that characterize the connections. This type of structure provides a strong internal structure to the entities and relationships. They also help in the storage and query of the information more efficiently.

Because of the efficiency and performance of storing and querying information in property graph format, one embodiment disclosed herein stores all interactions and contents of the user in an LPG format. Typically, there are a wide variety of open source native property graphs available including ArangoDB, Apache TinkerPop and Titan as well as commercial products like Neo4J.

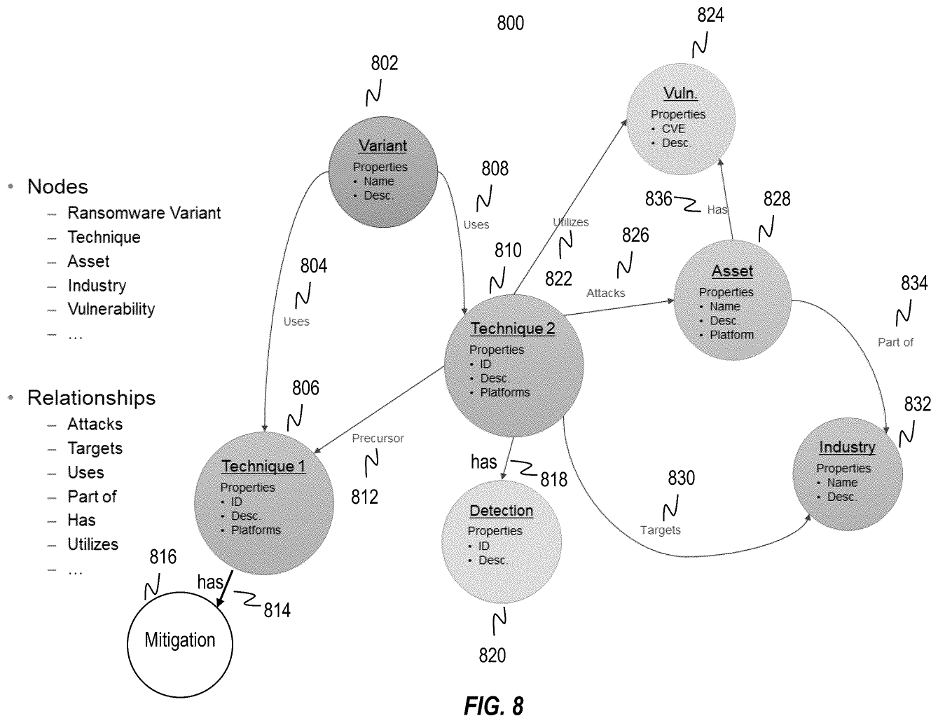

FIG. 8 shows an LPG 800 that depicts typical entities and relationships in a ransomware attack. As illustrated, the LPG includes nodes and relationships between the nodes. As illustrated in the LPG 800, the relationships between the nodes are graphically shown as connecting elements that connect the nodes as will be explained. It will be appreciated that the LPG 800 is a small example of what an LPG would look like in operation. Thus, in operation, an LPG could have thousands or even millions of nodes and relationships depending on the complexity of the ransomware attack and the size of the computing system and organization that is being subjected to the ransomware attack.

For example, a ransomware variant node 802 defines a specific ransomware variant. The ransomware variant node 802 has a relationship of “uses” 804 with an attack technique 1 node 806 and a relationship of “uses” 808 with an attack technique 2 node 810. Thus, the LPG 800 shows that the ransomware variant uses two attack techniques to perform a ransomware attack since the relationships 804 and 808 connect the ransomware variant node 802 with the attack technique 1 node 806 the attack technique 2 node 810.

The attack technique 1 node 806 and the attack technique 2 node 810 have a relationship of “precursor” 812 that shows that the attack technique 2 node 810 must happen before the attack technique 1 node 806. In addition, the graph shows that attack technique 1 node 806 has a relationship of “has” 814 with a mitigation node 816. Thus, the graph shows how a defender could mitigate the attack technique 1 node 806 using the properties of the mitigation node 814. As illustrated, the relationships connect the various nodes.

The graph shows that the attack technique 2 node 810 has a relationship of “has” 818 with a detection node 820. This shows that the technique 2 node 810 can be detected using the properties of the detection node 820. The graph shows that the attack technique 2 node 810 has a relationship of “utilizes” 822 with a vulnerability node 824. This shows that the technique 2 node 810 utilizes the vulnerabilities specified by the vulnerability node 824 during the ransomware attack. The graph shows that the attack technique 2 node 810 has a relationship of “attacks” 826 with an asset node 828. This shows the types of assets the attack technique 2 node 810 attacks during the ransomware attack. The graph shows that the attack technique 2 node 810 has a relationship of “targets” 830 with an industry node 832. This shows the types of industries the attack technique 2 node 810 targets during the ransomware attack. As illustrated, the relationships connect the various nodes.

The graph further shows that the asset node 828 has a relationship of “part of” 834 with the industry node 832. This shows that the asset node 828 is part of the industry node 832. The graph shows that the asset node 828 has a relationship of “has” 836 with the vulnerability node 824. This shows that the asset node 828 has the vulnerabilities specified by the vulnerability node 824. As illustrated, the relationships connect the various nodes.

These graph stores are utilized as the platform for threat intelligence domain knowledge repository to store, reveal and query data relationships. Graph database will enable the repository to traverse and analyze any level of depth in real-time as well as add context and connect new data on the fly. This will provide a solid foundation for maintaining the threat memory and accelerate the growth and sustenance of long-term knowledge. The repository is enriched with more data (raw and derived) over time, resulting in a graph that has more details, context, truth, intelligence, and semantics. This enables an efficient mechanism to search the information captured in the graph in a meaningful manner, yielding in knowledge, both directly and indirectly (new insights are discovered).

Expert Graph databases provide multitude of query languages to retrieve the entities/concepts and relationships. For example, Gremlin is a graph traversal language used by Apcahe TinkerPop, Cypher is a SQL like query language used by Neo4J while SPARQL is a query language used by RDF triple repositories.

### C.2.3 Aspects of an Example Threat Prediction Engine

The threat prediction engine 214 is responsible for predicting a ransomware threat when a specific pattern is noticed. This is achieved by leveraging a sophisticated Machine Learning based classifier and training it using the threat intelligence metadata 211 stored in the ransom attack repository 212. Enterprises often use various products like Crowdstrike, VMWare Carbon black and PaloAlto Networks that uses sensors to monitor activities. Although many of these products have built-in policies to capture some threats, they do lack a considerable knowledge and insights for all types of threat prediction. The threat prediction engine 214 augments that capability by using the ML classifier trained with the threat intelligence metadata 211. These security products can send the sensor data which then can be used by the threat prediction engine 214 to predict if there is a threat or not. In case of being identified as a threat, the threat prediction engine 214 can query the ransom attack repository 212 for the mitigation or defense such as the mitigation specified by the mitigation node 816. In an embodiment, the mitigation steps specified in the ransom attack repository 212 can be automated, thus achieving automation of ransomware threat handling.

Considering that a ransomware attack has many unique values, the embodiments disclosed herein utilize a sophisticated version of boosting algorithm that can handle categorical data without requiring to encode them. This unique algorithm, known as Categorical Boosting (CatBoost) is a customized version of the Gradient Boosting algorithm that can work on the categorical data in the training data set without using expensive encoding mechanisms.

In an embodiment, the threat prediction engine 214 uses a supervised learning approach for training with the features that include assets, vulnerabilities, variants, techniques, and industry, etc. for prediction. Once a threat is predicted by the threat prediction engine 214, the threat prediction engine 214 uses the ransom attack repository 212 to query and extract other related entities including the mitigation plan. This prediction of threat type enables the automation of ransomware threat handling in the enterprise.

On embodiment disclosed herein implements a shallow learning approach. The shallow learning approach is appropriate when there is less data dimensions and thus less efforts are expected for training the ML model. As a shallow learning option, an ensemble boosting technique with CatBoost, a customized version of gradient boosting algorithms, is utilized as a multi-class classification approach for predicting the class which is the optimal logistics provider.

The CatBoost algorithm is chosen for prediction and recommendation because of its efficiency and accuracy in processing huge volumes of data with categorical values and the ability of the algorithm to directly use categorical data without encoding them. CatBoost is a sophisticated version of the gradient boosting algorithm that uses “boosting” to generate predictions; this includes using multiple classifiers (this is usually done sequentially with each step corrects on the errors from the previous one) each trained on different data samples, and different features. This reduces the variance and the bias stem from using a single classifier. The final classification is achieved by aggregating the predictions that were made by the different classifiers.

CatBoost, like any other ensemble algorithm, combines several weak learners into a strong learner. Typically, weak learners that use decision trees predict slightly better than random predictions. By combining multiple weak learners and learning from the errors of them (each model fixes the error of its predecessor), the algorithm can improve the predictions in a sequential manner. Categorical Boosting is selected in some embodiments compared to the other types of boosting (AdaBoost, GradientBoosting, XGBoost, etc.) due to its ability to handle categorical data without encoding, its high performance, and the necessity of simple hyperparameter tuning.

CatBoost is composed of multiple decision trees, and each decision tree is constructed using different features and different data samples which reduces the bias and variance. In the training process the trees are constructed using the training data, in the testing process each new prediction that needs to be made runs through the different decision trees, each decision tree yields a score and the final prediction in determined by voting to determine which class got the most votes. In the embodiments disclosed herein, the CatBoost classifier uses multi-class classification, meaning the results of the classification would be one of many different Logistic Providers. The multiple independent variables (X values) are the assets, variants, techniques, industry, etc., whereas the target variable (Y value) is the vulnerability by the model.

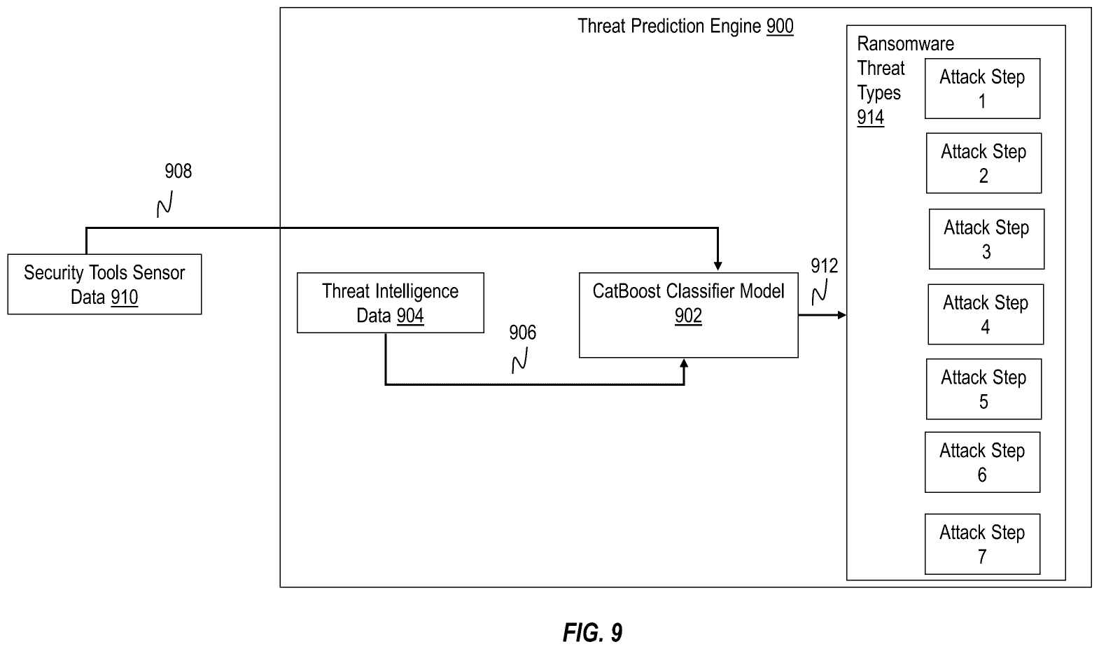

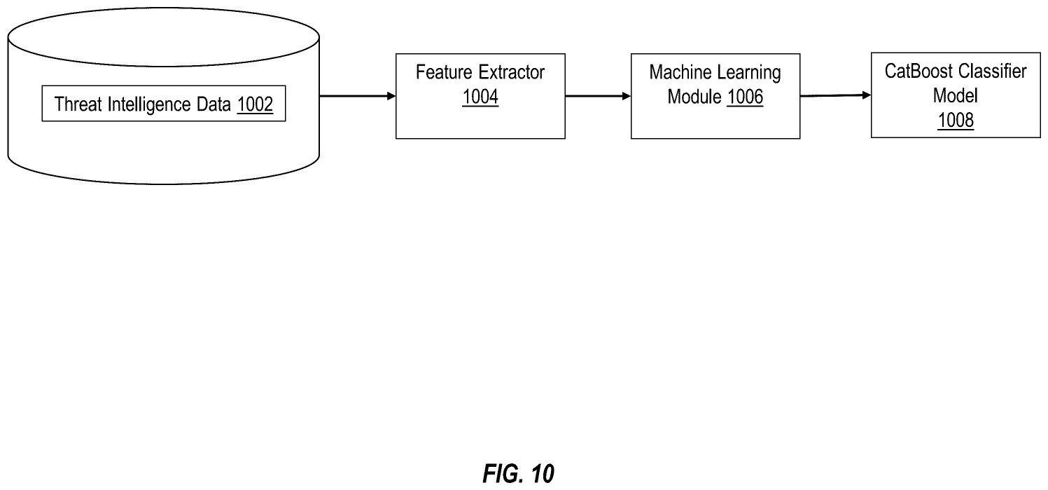

FIG. 9 illustrates an embodiment of a threat prediction engine 900 that corresponds to the threat prediction engine 214. The threat prediction engine 900 which may comprise a CatBoost classifier model 902 that is used to predict a ransomware threat type. As shown in FIG. 9, various inputs may be provided to the CatBoost classifier model 902. One such input to the CatBoost classifier model 902 may comprise threat intelligence data 904, which may correspond to the threat intelligence metadata 211 stored in the ransom attack repository 212. In an embodiment, the threat intelligence data 904 may be used to train 906 the CatBoost classifier model 902 as described in relation to FIG. 10.

FIG. 10 illustrates an embodiment of an example ML training network 1000 that is configured to use threat intelligence data to train a CatBoost classifier model. As illustrated, the ML network 1000 includes threat intelligence data 1002, which may correspond to the threat intelligence metadata 211 previously described. The threat intelligence data 1002 is processed by a feature extractor 1004 configured to extract features from the threat intelligence data 1002. The extracted features are then used by the machine-learning module 1006 to train a CatBoost classifier model 1008, which may correspond to any of the CatBoost classifier models previously described.

Returning to FIG. 9, the trained CatBoost classifier model 902 may then be used to predict 912 ransomware threat types 914. Thus, the trained CatBoost classifier model 902 may receive 908 security tools sensor data 910, which may correspond to the security tools sensor data previously discussed, and may make 112 the ransomware threat type predictions.

As illustrated, the ransomware threat types 914 that may be predicted by the trained CatBoost classifier model 902 may include various attack steps of a ransomware attack. For example, the ransomware threat types 914 may correspond to the attack steps 1-7 discussed previously in relation to FIG. 1. Thus, the trained CatBoost classifier model 902 is able to detect a ransomware attack at different stages of the attack and based on the detected stage, is able to recommend possible mitigation strategies based on the stage of the attack. Thus, the mitigation strategies can be directed as needed for the specific ransomware threat type. For example, a mitigation strategy for attack step 1 (initial access) would likely be different than the mitigation strategy for attack step 3 (privilege escalation).

### D. Further Discussion

As apparent from this disclosure, example embodiments disclosed herein may possess various useful aspects and features. Some examples of these follow.

For example, an embodiment disclosed herein may introduce an intelligent and predictive framework for building a ransomware threat intelligence repository from the third-party threat knowledge sources, curated attack models and MITRE ATTACK frameworks and using an NLP model to extract threat entities and their relationships into a ransomware attack repository.

An embodiment disclosed may formulate programmatically, and with a high degree of accuracy, predict which transactions are potential ransomware attacks and which are normal transactions by leveraging a prediction ML model and training the model with threat intelligence data from the ransomware attack repository.

A further embodiment disclosed herein provides the ability to recommend threat mitigation techniques in case a transaction is predicted as a threat, thus enabling intelligent mitigation measures for ransomware.

### E. Example Methods

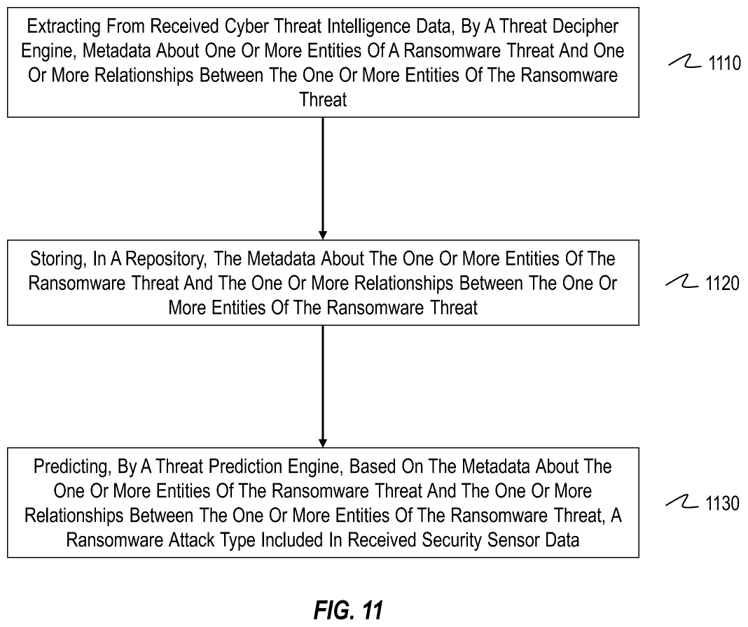

It is noted with respect to the disclosed methods, including the example method of FIG. 11, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 11, an example method 1100 is disclosed. The method 1100 will be described in relation to one or more of the figures previously described, although the method 1100 is not limited to any particular embodiment.

The method 1100 includes extracting from received cyber threat intelligence data, by a threat decipher engine, metadata about one or more entities of a ransomware threat and one or more relationships between the one or more entities of the ransomware threat (1110). For example, as previously described the threat decipher engine 208 extracts the threat intelligence metadata 211 from the cyber threat intelligence data stored in the cyber threat intelligence data store 202.

The method 1100 includes storing, in a repository, the metadata about the one or more entities of the ransomware threat and the one or more relationships between the one or more entities of the ransomware threat (1120). For example, as previously described the threat intelligence metadata 211 is stored in the ransomware attack repository 212. In some embodiments, the threat intelligence metadata 211 is stored as the Labeled Property Graph (LPG) 800 shown in FIG. 8.

The method 1100 predicting, by a threat prediction engine, based on the metadata about the one or more entities of the ransomware threat and the one or more relationships between the one or more entities of the ransomware threat, a ransomware attack type included in received security sensor data (1130). For example, as previously described the threat prediction engine 214 is trained by the threat intelligence metadata 211. The trained model then predicts ransomware threats found in sensor data received from the security tools 216.

### F. Further Example Embodiments

Following are some further example embodiments of the invention. These are presented only by way of example and are not intended to limit the scope of the invention in any way.

Embodiment 1. A method, comprising: extracting from received cyber threat intelligence data, by a threat decipher engine, metadata about one or more entities of a ransomware threat and one or more relationships between the one or more entities of the ransomware threat; storing, in a repository, the metadata about the one or more entities of the ransomware threat and the one or more relationships between the one or more entities of the ransomware threat; and predicting, by a threat prediction engine, based on the metadata about the one or more entities of the ransomware threat and the one or more relationships between the one or more entities of the ransomware threat, a ransomware attack type included in received security sensor data

Embodiment 2. The method as recited in any preceding embodiment, wherein the threat decipher engine comprises a Natural Language Processing (NLP) ML model.

Embodiment 3, wherein the NLP ML model uses Named Entity Recognition (NER) and Relationship Extraction (RE) techniques when extracting the metadata about the one or more entities of the ransomware threat and the one or more relationships between the one or more entities of the ransomware threat.

Embodiment 4. The method as recited in any preceding embodiment, wherein the threat prediction engine comprises a Categorical Boosting classifier ML model.

Embodiment 5. The method as recited in any preceding embodiment, wherein the Categorical Boosting classifier ML model is trained using the metadata about the one or more entities of the ransomware threat and the one or more relationships between the one or more entities of the ransomware threat.

Embodiment 6. The method as recited in any preceding embodiment, wherein the repository is a graph database and the metadata about the one or more entities of the ransomware threat and the one or more relationships between the one or more entities of the ransomware threat is stored in the graph database in graphical form.

Embodiment 7. The method as recited in any preceding embodiment, wherein the graphical form is a Labeled Property Graph (LPG).

Embodiment 8. The method as recited in any preceding embodiment, wherein the LPG includes one or more nodes that represent the one or more entities of the ransomware threat and one or more connecting elements that connect the nodes and that represent the one or more relationships between the one or more entities of the ransomware threat.

Embodiment 9. The method as recited in any preceding embodiment, wherein the ransomware attack type predicted by the threat prediction engine comprises a specific stage of the ransomware attack.

Embodiment 10. The method as recited in any preceding embodiment, further comprising: recommending, by the threat prediction engine, a mitigation strategy based on the predicted ransomware attack type.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

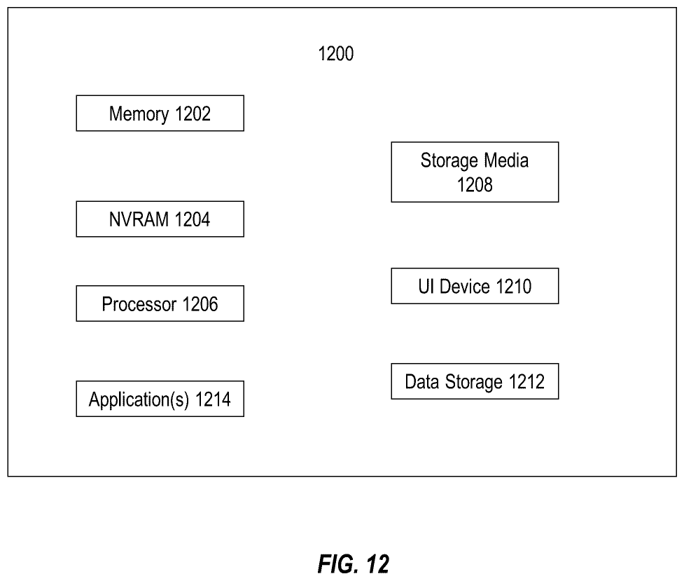

With reference briefly now to FIG. 12, any one or more of the entities disclosed, or implied, and/or discussed elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
extracting from received cyber threat intelligence data, by a threat decipher engine, metadata about one or more entities of a ransomware threat and one or more relationships between the one or more entities of the ransomware threat;
storing, in a repository, the metadata about the one or more entities of the ransomware threat and the one or more relationships between the one or more entities of the ransomware threat; and
predicting, by a threat prediction engine, based on the metadata about the one or more entities of the ransomware threat and the one or more relationships between the one or more entities of the ransomware threat, a ransomware attack type included in received security sensor data.

2. The method of claim 1, wherein the threat decipher engine comprises a Natural Language Processing (NLP) ML model.

3. The method of claim 2, wherein the NLP ML model uses Named Entity Recognition (NER) and Relationship Extraction (RE) techniques when extracting the metadata about the one or more entities of the ransomware threat and the one or more relationships between the one or more entities of the ransomware threat.

4. The method of claim 1, wherein the threat prediction engine comprises a Categorical Boosting classifier ML model.

5. The method of claim 4, wherein the Categorical Boosting classifier ML model is trained using the metadata about the one or more entities of the ransomware threat and the one or more relationships between the one or more entities of the ransomware threat.

6. The method of claim 1, wherein the repository is a graph database and the metadata about the one or more entities of the ransomware threat and the one or more relationships between the one or more entities of the ransomware threat is stored in the graph database in graphical form.

7. The method of claim 6, wherein the graphical form is a Labeled Property Graph (LPG).

8. The method of claim 7, wherein the LPG includes one or more nodes that represent the one or more entities of the ransomware threat and one or more connecting elements that connect the nodes and that represent the one or more relationships between the one or more entities of the ransomware threat.

9. The method of claim 1, wherein the ransomware attack type predicted by the threat prediction engine comprises a specific stage of the ransomware attack.

10. The method of claim 1, further comprising:
recommending, by the threat prediction engine, a mitigation strategy based on the predicted ransomware attack type.

11. A non-transitory storage medium having stored therein instructions that are executable by one or more hardware processors to perform operations comprising:
extracting from received cyber threat intelligence data, by a threat decipher engine, metadata about one or more entities of a ransomware threat and one or more relationships between the one or more entities of the ransomware threat;
storing, in a repository, the metadata about the one or more entities of the ransomware threat and the one or more relationships between the one or more entities of the ransomware threat; and
predicting, by a threat prediction engine, based on the metadata about the one or more entities of the ransomware threat and the one or more relationships between the one or more entities of the ransomware threat, a ransomware attack type included in received security sensor data.

12. The non-transitory storage medium as recited in claim 11, wherein the threat decipher engine comprises a Natural Language Processing (NLP) ML model.

13. The non-transitory storage medium as recited in claim 12, wherein the NLP ML model uses Named Entity Recognition (NER) and Relationship Extraction (RE) techniques when extracting the metadata about the one or more entities of the ransomware threat and the one or more relationships between the one or more entities of the ransomware threat.

14. The non-transitory storage medium as recited in claim 11, wherein the threat prediction engine comprises a Categorical Boosting classifier ML model.

15. The non-transitory storage medium as recited in claim 14, wherein the Categorical Boosting classifier ML model is trained using the metadata about the one or more entities of the ransomware threat and the one or more relationships between the one or more entities of the ransomware threat.

16. The non-transitory storage medium as recited in claim 11, wherein the repository is a graph database and the metadata about the one or more entities of the ransomware threat and the one or more relationships between the one or more entities of the ransomware threat is stored in the graph database in graphical form.

17. The non-transitory storage medium as recited in claim 16, wherein the graphical form is a Labeled Property Graph (LPG).

18. The non-transitory storage medium as recited in claim 17, wherein the LPG includes one or more nodes that represent the one or more entities of the ransomware threat and one or more connecting elements that connect the nodes and that represent the one or more relationships between the one or more entities of the ransomware threat.

19. The non-transitory storage medium as recited in claim 11, wherein the ransomware attack type predicted by the threat prediction engine comprises a specific stage of the ransomware attack.

20. The non-transitory storage medium as recited in claim 11, further comprising:
recommending, by the threat prediction engine, a mitigation strategy based on the predicted ransomware attack type.
